(19) United States
(12) Patent Application Publication
(10) Pub. No.: US 2015/0235042 A1
(43) Pub. Date: Aug. 20, 2015

(54) SYSTEMS AND METHODS FOR AUTHENTICATING AN APPLICATION

(71) Applicant: Symantec Corporation, Mountain View, CA (US)

(72) Inventors: Jonathon Salehpour, Upland, CA (US); Brian Witten, Hermosa Beach, CA (US); Bruce McCorkendale, Manhattan Beach, CA (US)

(73) Assignee: Symantec Corporation, Mountain View, CA (US)

(21) Appl. No.: 14/181,410

(22) Filed: Feb. 14, 2014

(51) Int. Cl. G06F 21/62; H04L 29/06

(52) U.S. Cl. CPC G06F 21/6218; H04L 63/08

(57) ABSTRACT

A computer-implemented method for authenticating an application is described. In one embodiment, a software package is received and the software package may be authorized based at least in part on an evaluation of the software package. Upon authorizing the software package, a signature file is embedded in a directory of the software package. A request to use a privileged service provided by a service provider is received from a client. In some embodiments, the request includes a custom class loader, the custom class loader being configured to construct a proxy object as an interface to the privileged service.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems may be used to carry out several business, industry, and academic endeavors. The wide-spread use of computers has been accelerated by the increased use of computer networks, including the Internet.

Many businesses use one or more computer networks to communicate and share data between the various computers connected to the networks. The productivity and efficiency of employees often require human and computer interaction. Users of computer technologies continue to demand an increase in the efficiency of these technologies. Improving the efficiency of computer technologies may be desirable to anyone who uses and relies on computers.

With the wide-spread of computers and mobile devices has come an increased presence of services for mobile devices. Services may include subscription services (e.g., newspapers and magazines), media services (e.g., streaming music, videos, etc.), and so forth. Currently, some service providers possess limited control over the processes involved in the authentication and revocation of the services they provide.

### SUMMARY

According to at least one embodiment, a computer-implemented method for authenticating an application is described. In one embodiment, a software package may be received and the software package may be authorized based at least in part on an evaluation of the software package. Upon authorizing the software package, a signature file may be embedded in a directory of the software package. A request to use a privileged service provided by a service provider may be received from a client. In some embodiments, the request may include a custom class loader, the custom class loader being configured to construct a proxy object as an interface to the privileged service.

In one embodiment, the request may include a custom class loader configured to construct a proxy object as an interface to the privileged service. The custom class loader may utilize a call to the privileged service to initiate validation of the client via the proxy object. In some cases, the client may be queried for information associated with the software package. The information associated with the software package may include at least one of a process ID, a user ID, a path to the software package, a path to an element of the software package, and one or more permissions associated with the software package.

In some embodiments, the signature file of the client may be evaluated to determine whether the signature file is valid. A signature file may be considered valid if the file is signed by the service provider. Upon determining the signature file is valid, a license of the client may be evaluated to determine whether the license is valid. Upon determining that the client is valid, a session token may be sent to the client and the client may be notified that the custom class loader is allowed to use the privileged service. The session token may enable the custom class loader to load one or more classes associated with the privileged service. In some cases, the session token received by the client may be stored at the client for subsequent use. Upon determining that the client provides a valid session token with the request, the client may be granted access to the requested service. Upon verifying the valid session token, the validation process, by which the session token may have been previously granted, may be bypassed.

In one embodiment, a new privileged service may be added by the service provider in addition to the one or more privileged services already offered by the service provider. The service provider may serve the new privileged service to the client without modifying any file in the software package, the software package including the application by which the client requests access to a service provided by the service provider. In some cases, upon determining the client is invalid, the validation process may be terminated and an error code may be sent to the custom class loader, the error code indicating that the client is invalid. Additionally, or alternatively, upon determining the client is invalid, a dummy object may be created in which all calls made in relation to the dummy object comprise a no operation (no-op). In some cases, the dummy object may replace an actual object.

A computing device configured to authenticate an application is also described. The device may include a processor and memory in electronic communication with the processor. The memory may store instructions that are executable by the processor to receive a software package and authorize the software package based at least in part on an evaluation of the software package, upon authorizing the software package, embed a signature file in a directory of the software package, and receive, from a client, a request to use a privileged service provided by a service provider.

A computer-program product to authenticate an application is also described. The computer-program product may include a non-transitory computer-readable medium that stores instructions. The instructions may be executable by a processor to receive a software package and authorize the software package based at least in part on an evaluation of the software package, upon authorizing the software package, embed a signature file in a directory of the software package, and receive, from a client, a request to use a privileged service provided by a service provider.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating another embodiment of an environment in which the present systems and methods may be implemented;

FIG. 3 is a block diagram illustrating one example of an authentication module;

FIG. 4 is a block diagram illustrating another embodiment of an environment in which the present systems and methods may be implemented;

FIG. 5 is a flow diagram illustrating one embodiment of a method for authenticating an application;

FIG. 6 is a flow diagram illustrating one embodiment of a method for validating a client;

FIG. 7 depicts a block diagram of a computer system suitable for implementing the present systems and methods; and

FIG. 8 is a block diagram depicting a network architecture in which client systems, as well as storage servers (any of which may be implemented using the computer system).

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The systems and methods described herein relate to authenticating an application. More specifically, the systems and methods described herein relate to authenticating an application in association with one or more client devices. The client devices may include one or more remote devices. In some cases, a client device may include a mobile device such as a cell phone, smart phone, tablet computing device, laptop, and the like. The systems and methods described herein allow a provider of privileged services to transparently and securely authenticate one or more clients seeking access to the provided services. The techniques described herein may be used with any service, and do not require that the service be provided in the manifest file of the client's application. Examples of privileged services include security services, licensed and/or subscription services (e.g., news services, etc.), a cloud storage service, a media provider service, and the like. In some cases, the systems and methods enable the service provider to grant an application running on the client access to one or more of its services. Additionally, or alternatively, the systems and methods enable the service provider to revoke access to one or more of its services. Thus, the systems and methods described herein may enable the service provider to grant access and/or revoke access to one or more of its services independent of application vendors (e.g., GOOGLE® Play, AMAZON® App Store, etc.), device manufacturers (e.g., SAMSUNG®, LG®, etc.), and/or processes related to application coding and development.

In one embodiment, the systems and methods described herein provide secure and transparent authentication of clients in relation to privileged services provided for any architecture that supports remote procedure calls and dynamic class loading (e.g., C#, Python, Android, JAVA®, etc.), thus providing an ability to validate a client's entitlement to a privileged service without depending on the conventional approach to validation (e.g., the Android permission model using the built-in “Bounded Service”). For example, a client on an Android device may request to utilize one or more services where each service is developed by a different service owner (e.g., an application that uses camera and BLUETOOTH® services). In a conventional Android system, prior to offering any service, a developer would have to modify the client application's manifest file (e.g., AndroidManifest.xml file) to add one or more permissions for each service requested. Subsequently, if one or more services were to be added and/or removed, the developer would again have to modify the Android application package file (APK) to add/remove permissions from the manifest file. The problem, however, is that each time the manifest is modified, a developer must re-sign the APK with a developer certificate, resubmit the application to an application vendor, wait for an application review board to review the resubmitted application, and if approved, publish the application, and then hope that the end-user will update the application to this latest version with the modified permissions.

From the foregoing, the conventional system does not allow a service provider to dynamically control access to a service or to determine in real-time who can and cannot access a service. The service and methods described herein, however, enable a service provider to control access to privileged services and dynamically determine at runtime who can and cannot access the services without requiring any modifications to the operating system framework such as adding custom permissions to a manifest file, as is required with the conventional implementation. The systems and methods described herein simplify the process of granting a client access to a requested service and places control of the service with the service provider.

Accordingly, the solutions described herein are performed independent of the conventional permission model, such as the Android built-in mechanism of using “Bound Services.” In the present solution, an application may not be granted access to a privileged service by simply providing the applicable permission in a manifest file. Whether a legitimate application requests access to such a privileged service or a malicious non-customer application access the privileged service, the validation routine described herein is performed.

In one embodiment, the systems and methods described herein may extend a remote procedure call (e.g., binder RPC) to securely and transparently validate clients requesting to use privileged services. In some embodiments, a client may upload an application to a service provider's portal to allow the service provider to evaluate the application. If the application is accepted by the service provider, the service provider may embed a signature file that uniquely identifies the service provider in an information directory of the application (e.g., a meta-INF folder). Once the client's application is deployed on the device and the application attempts to use a service, the service may be configured to dynamically validate the client. In some cases, the client may request access to a privileged service. In one embodiment, the client's application may attempt to use a privileged service by creating an object (e.g., a proxy object) that uses the requested service. Within the object construction, the routine may call a class loader responsible for loading the service class. The class loader may make a request to the service to determine whether the class loader has permission to construct an actual object associated with the service. Accordingly, the service may receive a request from the client to use its service via the class loader. Such interaction between a service and a client may be enabled by utilizing binders, sockets, shared memory, D-Bus, intents, and the like.

At one point in the validation, the service may query the client for information regarding the application. The information may include a process ID, a user ID, a path associated with the application, one or more permissions, etc. The service may determine whether any portion of the information provided (e.g., process ID, user ID, etc.) is on a blacklist. If a process and/or user have already been deemed malicious (e.g., a portion of the information provided is associated with the blacklist), the service may short-circuit the validation logic, terminating the validation process. In some cases, the service may return to the client's class loader a message indicating that the client is invalid. Upon determining no portion of the application information provided by the client is associated with a blacklist, the service may investigate a license and/or certificate information associated with the client. In some cases, the service may validate a client's signature file (e.g., an assertion file such as a SYMANTEC® Sealed Certificate) to determine whether the signature file is signed by the service provider's signing portal. Upon determining that the signature file is valid, the service may determine whether the client's license is revoked or expired. Upon determining the client is valid, the service may grant access to the requested service.

Once the service determines that the client is valid, the service may construct a session token. The client may send the session token to the client along with the response that the client is allowed to use the service. In some cases, the class loader may store the session token for subsequent use on a storage device of the client. The cached session token may be used as an optimization to the validation process so that the service does not have to re-validate the client connection upon a subsequent request. Accordingly, if a token is provided by the client in relation to a request, the service may perform a lookup on the session token cache to see if the client has already been permitted access to the service. If so, the service may respond that the client's class loader is permitted to load the appropriate class that is associated with the requested service. On the other hand, if the service determines that the client's session token has been revoked and/or expired, the service may send an error message to the client. Additionally, or alternatively, if the client does not provide a token or the service determines that the client's session token has been revoked and/or expired the service may initiate the validation process to determine whether to allow the client to access the requested service. As described above, when the service evaluates the client context, the service may perform at least one of the following operations: read a signature file associated with the client's application and determine whether the signature file has been signed properly, perform a lookup on the signature file to determine that it is still valid (e.g., online certificate status protocol (OCSP), public key infrastructures (PKIs), certificate revocation lists (CRLs), etc.), and perform license lookup to determine that the client's license is still valid. Once the client's application has been authenticated and has been authorized to use the service, the client may be notified that the class loader is permitted to construct “real” service objects and make requests to the service.

In some cases, the service may collect and store information related to the client making a request for a privileged service. Accordingly, if a certain client is denied access, the service may store information regarding the client, and upon detecting the same client again attempting to gain access to the same privileged service (e.g., due to being on a blacklist, etc.), the service may merely send an error message to the client without initiating the validation process.

It is also noted that under the conventional method, if a client attempts to access a service not specified in the manifest file, the application will crash, resulting in a bad user experience. Conversely, if a client attempting to access a privileged service under the methods and systems described herein is denied access, the application does not fail. Instead, the service may send the client an error message, by which the application may provide a notification on the client device indicating that access is denied. As a result, the application may simply receive a no-op dummy instance of the service returned, and a user may continue to use other features still available on the application.

As described above, a developer may submit an application to the service provider for vetting after which, the service provider's signature file may be embedded into a folder of the application, which does not require a developer to modify and/or re-sign an application as it would in a conventional system. The systems and methods described herein are independent of the conventional permission model and enable the service provider to manage and control its own valuable resources using its own key-set. Thus, in some embodiments, a service provider may provide a new service and dynamically grant access to the newly available service by simply embedding a signature file in a folder of an application package file and implementing the validation process described herein. Moreover, because access to a service is controlled by the service provider, the service provider may revoke the client's right to the service in real-time.

Another advantage of the present systems and methods is the manner in which a client is validated. Allowing the service to add a signature file into a directory of the application enables the service provider to revoke access to valuable services, and to do so through a key-set managed by the service provider, and not a process managed by the application vendor, a mobile service carrier, or a device manufacturer, thus enabling service providers to more securely and more efficiently control access to their valuable services. Another advantage to the systems and methods described herein is that the validation process is transparent to the client, as the client does not have any control over the validation process. The validation process is performed outside of the client's control since validation is performed in relation to the class loader responsible for constructing objects associated with the service. Under the systems and methods described herein, it is not possible for a client to know whether it is using a “real” object or a “dummy” object (e.g., empty substitute). The client is simply aware that it is making a request and whether the request is being handled or not. Accordingly, the validation process described herein is not as vulnerable to tampering or privilege escalation as is the case with conventional methods. In conventional systems where the client is aware of a validation process, the client may be able to continuously and repeatedly attempt to access the service, providing means for a denial-of-service (DoS) attack. With the present systems and methods, however, if the client is malicious or misbehaves, its privileges may be revoked dynamically in real-time. In some cases, where access to a service has been granted, the service may revoke access by replacing the “real” object loaded by the class loader with a “dummy” object in which all calls result in a no-op, effectively turning off the client's access to the service. These features are not possible using the conventional “Bound Service” implementation as the conventional method requires an explicit “bindService” call and the session is managed explicitly by the client. Accordingly, the methods and systems described herein enable a service provider to have full control over the process of granting access to one or more privileged services, being enabled to dynamically select on the fly which clients can and which clients cannot access the privileged service.

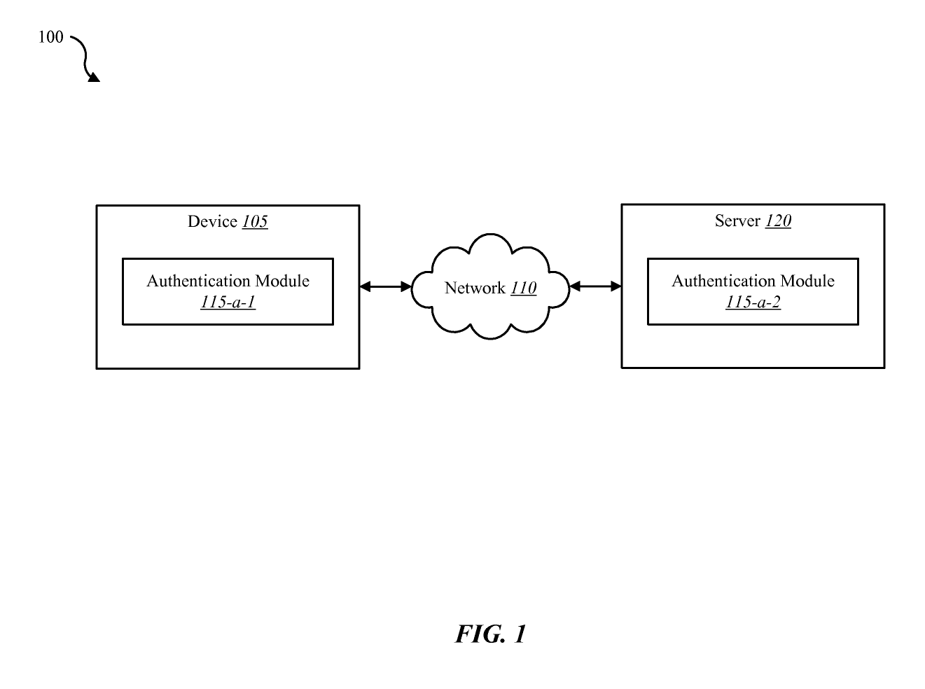

FIG. 1 is a block diagram illustrating one embodiment of an environment 100 in which the present systems and methods may be implemented. In some embodiments, the systems and methods described herein may be performed on a single device (e.g., device 105 or server 120) or on two or more devices such as device 105 and server 120. As depicted, environment 100 may include device 105, network 110, and server 120. Examples of device 105 include mobile computing devices, smart phones, personal computing devices, computers, servers, etc.

In some cases, device 105 may connect to server 120 via network 110. Examples of network 110 include any combination of local area networks (LAN), wide area networks (WAN), virtual private networks (VPN), wireless networks (using 802.11, for example), cellular networks (using 3G and/or LTE, for example), etc. In some configurations, the network 110 may include the internet. Thus, network 110 may include one or more gateway devices, access points, routers, switches, dynamic host configuration protocol (DHCP) servers, etc., that enable computing devices to connect to the internet.

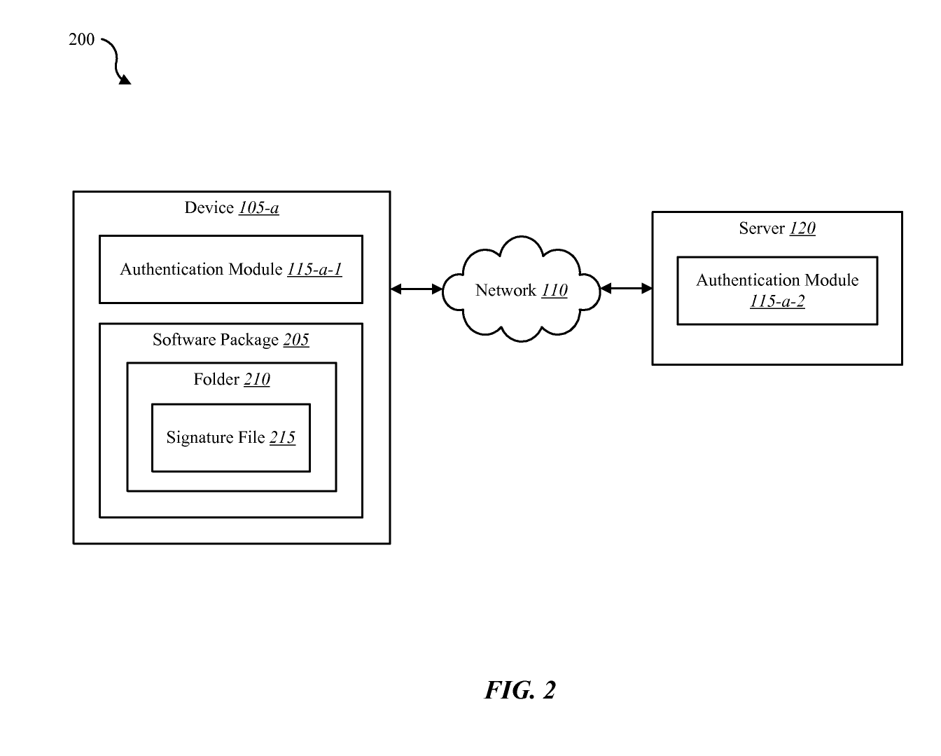

Server 120 may serve one or more privileged services. Thus, server 120 may be referred to as a service provider. An authentication module 115-a-1, 115-a-2 may be located on device 105 and/or server 120. Although devices 105 and server 120 are depicted including module 115-a, in some embodiments, one of the depicted devices may not include an authentication module 115-a. In some cases, device 105 may include an application that allows device 105 to interface with the authentication module 115-a-2 located on server 120. In some embodiments, both devices 105 and server 120 may include at least a portion of authentication module 115-a, where at least a portion of the functions of authentication module 115-a are performed on device 105 and another portion of the functions are performed on server 120. In some cases, any combination of the functions of authentication module 115-a are performed concurrently and/or separately on device 105 and server 120. In some configurations, an application may enable device 105 to interface with the authentication module 115 to request access to a service provided by server 120, to authenticate the application, and upon validating device 105-a and/or the application, granting device 105-a access to the requested service. Thus, authentication module 115-a may be configured to authenticate an application in relation to a client (e.g., device 105) requesting access to a service provided by server 120. Further details regarding the authentication module 115-a are discussed below with regards to FIGS. 2 and/or 3.

FIG. 2 is a block diagram illustrating another embodiment of an environment 200 in which the present systems and methods may be implemented. As depicted, environment 200 may include device 105-a, network 110, and server 120. Device 105-a may be one example of device 105 depicted in FIG. 1. Device 105-a may include authentication module 115-a-1 and software package 205. Software package 205 may include folder 210, which, as depicted, may include signature file 215.

In one embodiment, a user may submit, via network 110, an unsigned software package to a signing portal associated with server 120. For example, a developer of an application may submit a software package that includes the developed application and other files to a signing portal for evaluation. Authentication module 115-a-1 may evaluate the submitted unsigned software package and verify that the software package is free from malware and not associated with entities that develop and/or distribute malware. Authentication module 115-a-1 may digitally sign the submitted software package without modifying any files in the software package, including a manifest file, the application file, etc. The developer may make the signed software package available for installation. Thus, in one embodiment, device 105 may install the signed software package 205. As a result, device 105 may run an application from the signed software package 205, and from this application, device 105 may request access to a service offered by server 120. As a result of this request, authentication module 115-b-1 may validate device 105 and/or the application running on device 105. Upon validating device 105 and/or the application, authentication module 115-a-1 may provide device 105 access to the requested service.

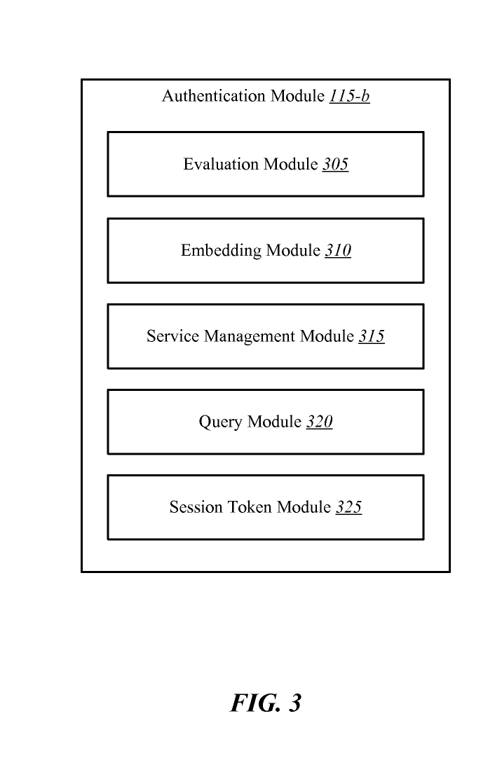

FIG. 3 is a block diagram illustrating one example of an authentication module 115-b. The authentication module 115-b may be one example of the authentication module 115 depicted in FIGS. 1 and/or 2. As depicted, the authentication module 115-b may include an evaluation module 305, an embedding module 310, a service management module 315, a query module 320, and a session token module 325.

In one embodiment, evaluation module 305 may receive a software package. Examples of software packages may include Android application package files (APKs), JAVA® archive files (JARs), and the like. The evaluation module 305 may evaluate the software package received. For example, the evaluation module 305 may scan the software package to determine whether the software package contains malware, to determine whether any aspect of the software package is associated with malware (e.g., software developer is on a blacklist, etc.), to verify an identity associated with the software package (e.g., software developer identity, etc.), and the like. In some embodiments, evaluation module 305 may authorize the software package based at least in part on the evaluation of the software package. Upon authorizing the software package, embedding module 310 may embed a signature file in a directory associated with the software package.

In one example, a user may upload a software package via a web browser to allow the evaluation module 305 to evaluate the software package. Upon verifying the software package, the embedding module 310 may sign the software package, i.e., embed an assertion file in the software package. In some cases, embedding module 310 may embed a signature file in an information folder associated with the software package. For example, in the Android environment, embedding module 310 may embed a signature file in a meta-INF folder of the software package. It is noted that embedding a file in the software package does not modify any file in the software package. The only change is that a file is added to a folder of the software package.

In one embodiment, service management module 315 may receive, from the client, a request to use a privileged service provided by a service provider. Thus, if a software package passes verification, the embedding module 310 may sign a file with a private key controlled by the service provider and embed the signed file in the meta-INF folder. The service management module 315 may verify, at runtime, that the signed file is signed by the service provider with its private key. In one example, unique key-pairs may be used for each signing event. Thus, in some cases, the file embedded in the software package may be considered an indicator that an application associated with the software package is authorized to access a requested service.

In one embodiment, the service management module 315 may operate in conjunction with a custom class loader in the validation process. In some cases, the request may include a custom class loader constructing a proxy object as an interface to the privileged service. The custom class loader may utilize a call to the privileged service to initiate validation of the client via the proxy object. In some cases, the custom class loader may utilize binders, sockets, shared memory, D-Bus, and/or intents to enable interaction between a service and a client.

In one embodiment, query module 325 may query the client for information associated with the software package. In some cases, the client may be queried via a binder connection. The information associated with the software package may include at least one of a process ID, a user ID, a path to the software package, a path to an element of the software package, one or more permissions associated with the software package, and the like. In some embodiments, service management module 315 may evaluate the signature file of the client to determine whether the signature file is valid. A signature file may be considered valid when the file is signed by the service provider. Upon determining the signature file is valid, service management module 315 may evaluate a license of the client to determine whether the license is valid. In some cases, upon determining that the client is valid, session token module 320 may send a session token to the client. Thus, once the service has determined that the client is valid, session token module 320 may construct a session token and send the session token to the client along with the response that it is allowed to use the service. In one embodiment, the client may be considered valid if the information associated with the software package is validated, the signature file of the client is validated, and/or the license of the client is validated. In some embodiments, a validation process may be bypassed if the client provides a valid session token with its request for a service. Thus, the session token may be used as an optimization so that the service may not have to re-validate the client connection on each subsequent request. In some embodiments, upon determining the client provides a previously granted session token with the request, session token module 320 may verify the previously granted session token, and upon verifying the previously granted session token is valid, session token module 320 may grant the client access to the requested service. Accordingly, in some cases, the client may bypass the validation process by providing a session token with its request.

In one embodiment, the session token may enable the custom class loader to load one or more classes associated with the privileged service. In one embodiment, the session token received by the client may be stored at the client for subsequent use. In some cases, the class loader may store the session token in a cache or storage device located on the client. On each call to the service, the client code may provide this session token in order to gain access to the service. Otherwise, the service may reject the call. In some cases, the client may treat the session token as an unknown entity and pass the token (unbeknownst to the client) back to the service whenever the client makes a call to the service. If the client modifies the session token, its session may be closed and its request may be denied. The service, on the other hand, may be privileged to modify the session token in any way it likes on each call. For example, on each client call, the service may increment the session token, update the session token by hashing it using a salt, and/or generate a new session token to replace the previous session token.

In some embodiments, upon determining the client is invalid, service management module 315 may terminate the validation process and send an error code to the custom class loader. The error code may indicate the client is invalid (e.g., client is blacklisted, access is now revoked, or the client is no longer valid). Upon determining the client is invalid, service management module 315 may create a dummy object in which all calls made in relation to the dummy object include a no operation (no-op). In some cases, service management module 315 may revoke access to a privileged service by generating a dummy object and replacing an actual object with the dummy object, effectively cutting off access to the privileged service. As described above, the custom class loader that constructs the proxy object may make an RPC to a service to validate the client. Once the service determines whether the client is valid, the service may reply to the class loader to load the appropriate class. If the client is deemed valid by the service, the class loader may load the actual class in which each invocation on the object will be a valid RPC call to the service. On the other hand, if the service determines that the client is not valid, the class loader may create a “dummy” object in which all calls result in a no-op. In some cases, a validated client may be subsequently invalidated by the service, in which case the service management module 315 may replace the “actual” object with a “dummy” object. For example, if the service management module 315 determines that a client is malicious and/or abusing its privilege, the service management module 315 may revoke access. To revoke the client's service, the service provider may revoke the client's signature file (e.g., using OCSP, PKIs, and/or CRLs), add the client and/or the application to a blacklist, list a serial number of a particular certificate used to sign a signature file on a revocation list, revoke the certificate used to sign the file, and/or delete a session token from the client's cache. A client may be invalidated or their privileges revoked seamlessly since the client authentication process is dynamic as opposed to the static approach of embedding static permissions in a manifest file.

The service provider may dynamically control access to services in real-time, and the service provided may be enabled to revoke those rights that have been granted independent of an application submission process and without modification to any file in the software package.

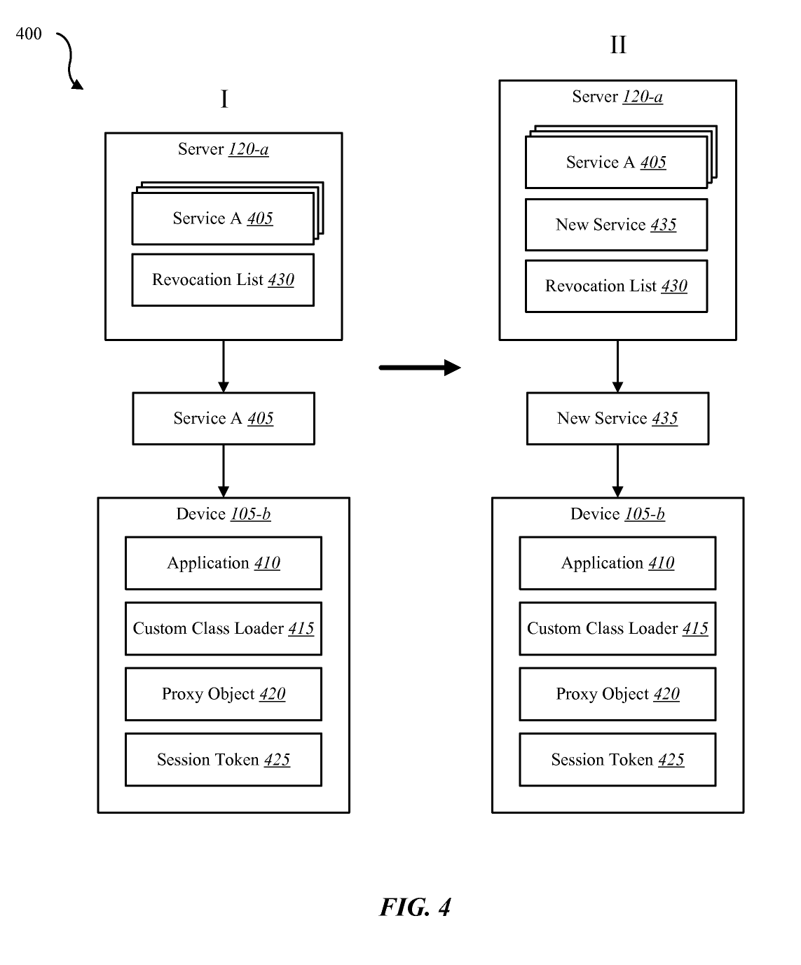

FIG. 4 is a block diagram illustrating another embodiment of an environment 400 in which the present systems and methods may be implemented. As depicted, environment 400 may include a server 120-a and a device 105-b. The server 120-a and device 105-b may be examples of server 120 and device 105, respectively, in FIGS. 1 and/or 2. Under the Roman numeral “I” on the left side of FIG. 4, environment 400 includes a depiction of server 120-a and device 105-b at a first state. Following the arrow in the center of FIG. 4, environment 400 includes a depiction of server 120-a and device 105-b at a second state under the Roman numeral “II” on the right side of FIG. 4.

Starting with the first state under the Roman numeral “I,” server 120-a includes service A 405 and revocation list 430. As depicted, server 120-a may include one or more other services in addition to service A 405. Device 105-b may include application 410, custom class loader 415, proxy object 420, and session token 425. As described above, a user may submit a software package for evaluation. Upon verifying the software package, a signature file may be embedded in the software package. The signed software package may include an application, such as application 410. A request may be initiated from device 105-b, via application 410, to utilize service A 405. In one embodiment, custom class loader 415 may generate proxy object 420 that interfaces the requested service, service A 405. Custom class loader 415 may make a request to server 120-a to determine whether custom class loader 415 has permission to construct an actual object associated with service A 405. The interaction between server 120-a and device 105-b may be enabled by utilizing binders, sockets, shared memory, D-Bus, intents, and the like. Accordingly, server 120-a may receive the request from device 105-b to access service A 405 via custom class loader 415, and upon validating device 150-a, server 120-a may generate session token 425. In some cases, device 150-a may receive session token 425, and custom class loader 415 may store session token 425 at device 105-b. In some cases, server 120-a may revoke device 105-b's access to service A 405. In one embodiment, server 120-a may add information associated with device 105-b to the revocation list 430 (e.g., process ID, user ID, information associated with session token 425, information associated with a signature file, etc.). Once revoked, device 105-b may be blocked from accessing service A 405.

Moving to the second state of server 120-a depicted in environment 400, in one embodiment, server 120-a may add a new privileged service 435 in addition to the one or more privileged services already offered by server 120-a. Thus, server 120-a may add service 435 in addition to service A 405 and any other services previously provided. In one embodiment, device 105-b may initiate a request, via custom class loader 415, to access the new privileged service 435. In some cases, device 105-b may include session token 425 along with the request for service 435, sending both to server 120-a. Upon receiving the request and session token 425, server 120-a may provide the new service 435 to device 105-b without putting device 105-b again through the validation process, by which device 105-b received session token 425. In some embodiments, server 120-a may serve the new privileged service 435 to device 105-b without modifying any file in the signed software package, including application 410. In some cases, server 120-a may modify or replace session token 425 in response to receiving the request for the new service 435. As a result, custom class loader 415 may cache the updated or replacement session token at device 105-b.

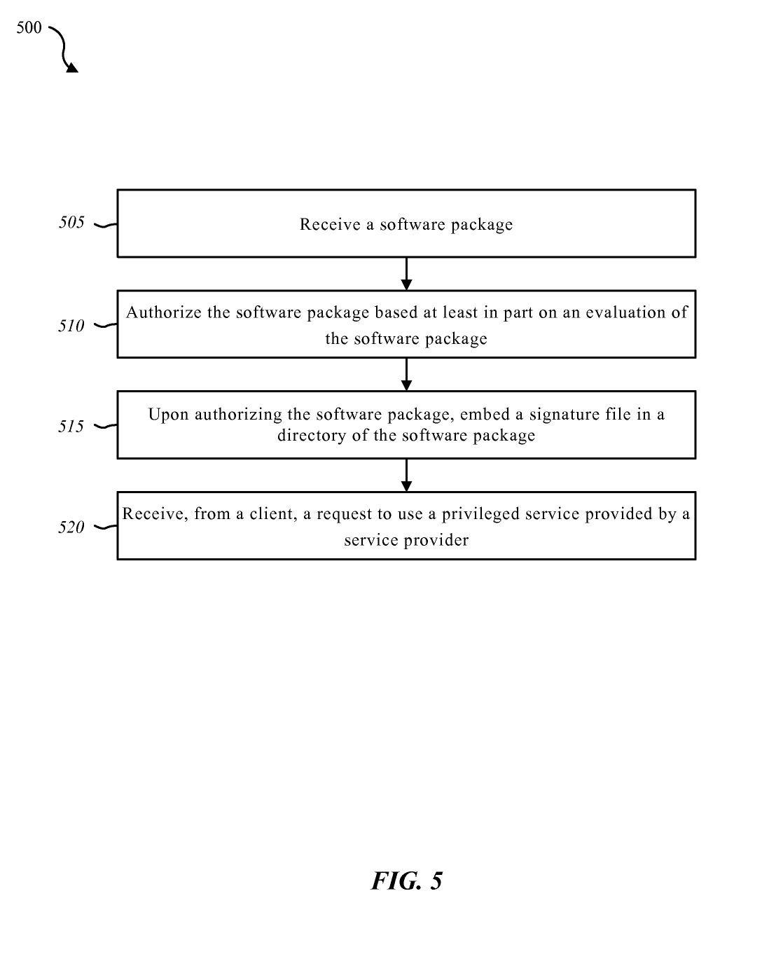

FIG. 5 is a flow diagram illustrating one embodiment of a method 500 for authenticating an application. In some configurations, the method 500 may be implemented by the authentication module 115 illustrated in FIGS. 1, 2, and/or 3.

At block 505, a software package may be received. At block 510, the software package may be authorized based at least in part on an evaluation of the software package. At block 515, upon authorizing the software package, a signature file may be embedded in a directory of the software package. At block 520, a request to use a privileged service provided by a service provider may be received from a client. In some embodiments, the request may include a custom class loader, the custom class loader being configured to construct a proxy object as an interface to the privileged service. In some cases, the custom class loader may generate a call to the privileged service, via the proxy object, which initiates a validation of the client. In some embodiments, the method 500 may include adding a new privileged service in addition to the one or more privileged services offered by the service provider, receiving, from a client, a request to use the new privileged service provided by the service provider, and serving the new privileged service to the client without modifying any file in the software package.

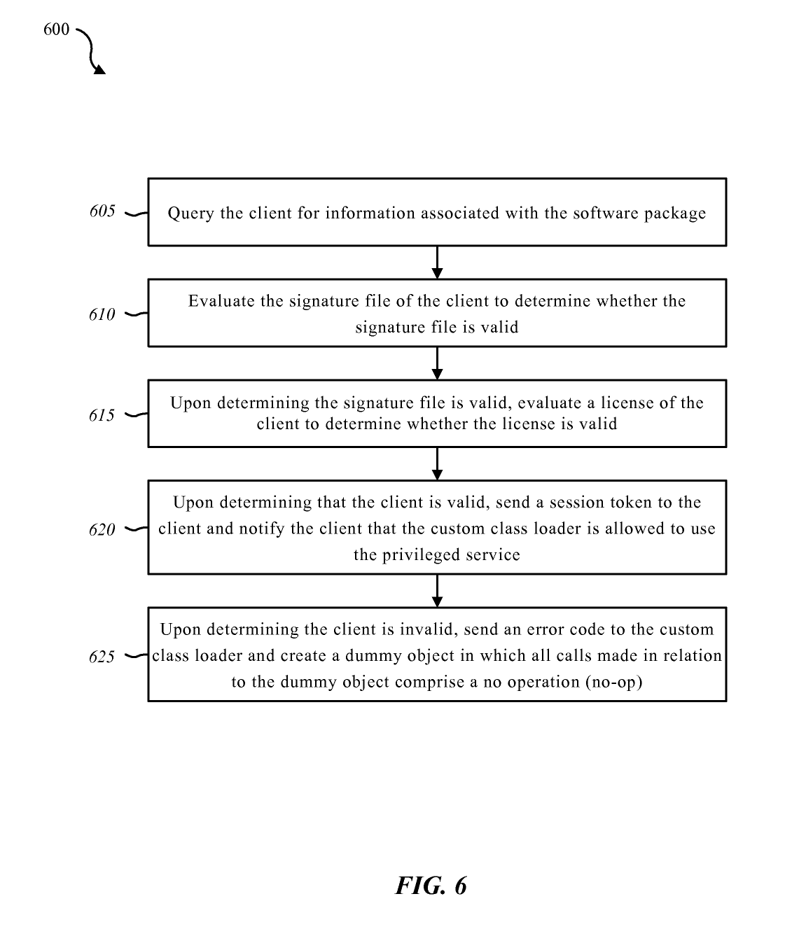

FIG. 6 is a flow diagram illustrating one embodiment of a method 600 for validating a client. In some configurations, the method 600 may be implemented by the authentication module 115 illustrated in FIGS. 1, 2, and/or 3.

At block 605, a selected website may be web crawled with an on-premises device located at a predetermined location and a server located at a location different from the predetermined location. At block 610, it may be determined whether the web crawl by the other device results in the other device identifying the same low prevalence file identified in the web crawl by the on-premises device. At block 615, upon determining the low prevalence file is detected at least by the other device, a reputation of the identified website may be reduced. At block 620, upon determining the low prevalence file is detected by the on-premises device, but not by the other device, a notification that the website may include selective malware may be generated. At block 625, upon determining the low prevalence file is detected only by the on-premises device, a request for additional devices to perform a web crawl of the identified website may be generated.

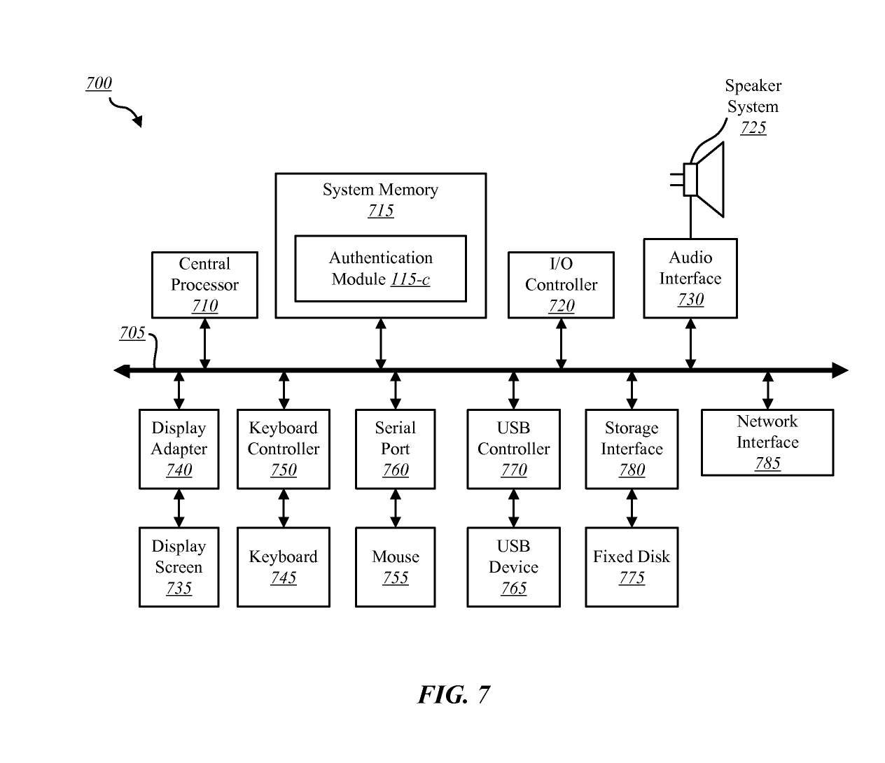

FIG. 7 depicts a block diagram of a computer system 700 suitable for implementing the present systems and methods. Computer system 700 includes a bus 705 which interconnects major subsystems of computer system 700, such as a central processor 710, a system memory 715 (typically RAM, but which may also include ROM, flash RAM, or the like), an input/output controller 725, an external audio device, such as a speaker system 725 via an audio output interface 730, an external device, such as a display screen 735 via display adapter 740, a keyboard 745 (interfaced with a keyboard controller 750) (or other input device), multiple USB devices 765 (interfaced with a USB controller 770), and a storage interface 780. Also included are a mouse 755 (or other point-and-click device) connected to bus 705 through serial port 760 and a network interface 785 (coupled directly to bus 705).

Bus 705 allows data communication between central processor 710 and system memory 715, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the authentication module 115-c to implement the present systems and methods may be stored within the system memory 715. Applications resident with computer system 700 are generally stored on and accessed via a non-transitory computer readable medium, such as a hard disk drive (e.g., fixed disk 775) or other storage medium. Additionally, applications can be in the form of electronic signals modulated in accordance with the application and data communication technology when accessed via interface 785.

Storage interface 780, as with the other storage interfaces of computer system 700, can connect to a standard computer readable medium for storage and/or retrieval of information, such as a fixed disk drive 775. Fixed disk drive 775 may be a part of computer system 700 or may be separate and accessed through other interface systems. Network interface 785 may provide a direct connection to a remote server via a direct network link to the Internet via a POP (point of presence). Network interface 785 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., document scanners, digital cameras, and so on). Conversely, all of the devices shown in FIG. 7 need not be present to practice the present systems and methods. The devices and subsystems can be interconnected in different ways from that shown in FIG. 7. The operation of a computer system such as that shown in FIG. 7 is readily known in the art and is not discussed in detail in this application. Code to implement the present disclosure can be stored in a non-transitory computer-readable medium such as one or more of system memory 715 or fixed disk 775. The operating system provided on computer system 700 may be iOS®, MS-DOS®, MSWINDOWS®, OS/2®, UNIX®, LINUX®, or another known operating system.

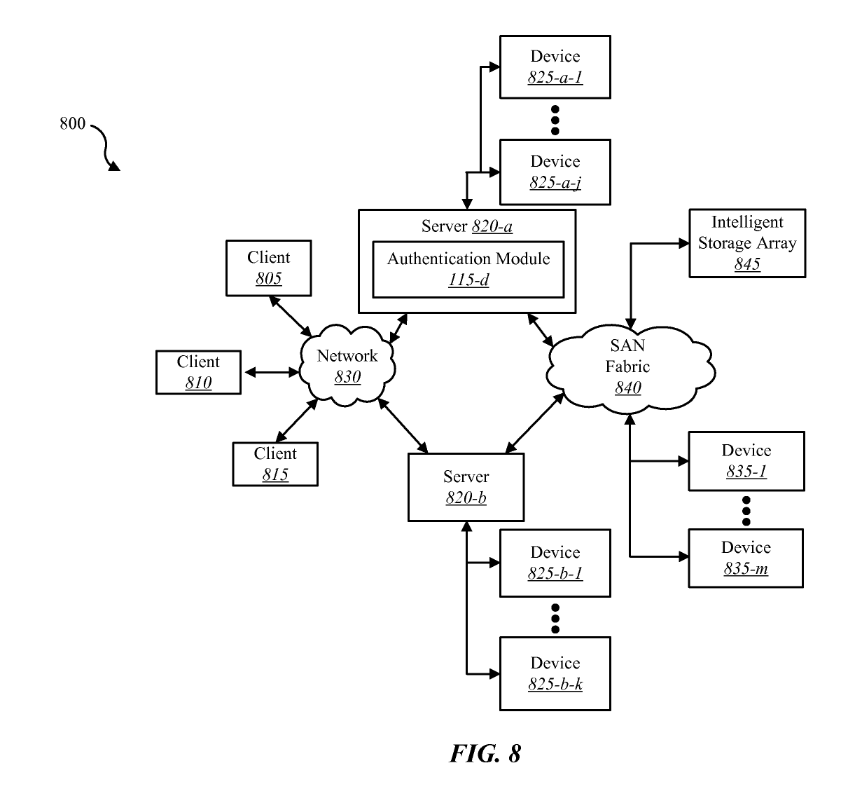

FIG. 8 is a block diagram depicting a network architecture 800 in which client systems 805, 810 and 815, as well as storage servers 820-a and 820-b (any of which can be implemented using computer system 700), are coupled to a network 830. In one embodiment, authentication module 115-d may be located within one of the storage servers 820-a, 820-b to implement the present systems and methods. Authentication module 115-d may be one example of authentication module 115 in FIGS. 1, 2, 3, and/or 7. The storage server 820-a is further depicted as having storage devices 825-a-1 through 825-a-j directly attached, and storage server 820-b is depicted with storage devices 825-b-1 through 825-b-k directly attached. SAN fabric 840 supports access to storage devices 835-1 through 835-m by storage servers 820-a and 820-b, and so by client systems 805, 810 and 815 via network 830. Intelligent storage array 845 is also shown as an example of a specific storage device accessible via SAN fabric 840.

With reference to computer system 600, network interface 685 or some other method can be used to provide connectivity from each of client computer systems 805, 810 and 815 to network 830. Client systems 805, 810 and 815 are able to access information on storage server 820-a or 820-b using, for example, a web browser or other client software (not shown). Such a client allows client systems 805, 810 and 815 to access data hosted by storage server 820-a or 820-b or one of storage devices 825-a-1-825-a-j, 825-b-1-825-b-k, 835-1-835-m or intelligent storage array 845. FIG. 8 depicts the use of a network such as the Internet for exchanging data, but the present systems and methods are not limited to the Internet or any particular network-based environment.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for authenticating an application, comprising:
receiving a software package;
authorizing the software package based at least in part on an evaluation of the software package;
upon authorizing the software package, embedding a signature file in a directory of the software package; and
receiving, from a client, a request to use a privileged service provided by a service provider.

2. The method of claim 1, wherein the request comprises a custom class loader constructing a proxy object as an interface to the privileged service, the custom class loader utilizing a call to the privileged service to initiate validation of the client via the proxy object.

3. The method of claim 2, further comprising:
querying the client for information associated with the software package, wherein the information associated with the software package includes at least one of a process ID, a user ID, a path to the software package, a path to an element of the software package, and one or more permissions associated with the software package.

4. The method of claim 2, further comprising:
evaluating the signature file of the client to determine whether the signature file is valid, wherein a valid signature file is signed by the service provider.

5. The method of claim 4, further comprising:
upon determining the signature file is valid, evaluating a license of the client to determine whether the license is valid.

6. The method of claim 2, further comprising:
upon determining that the client is valid, sending a session token to the client and notifying the client that the custom class loader is allowed to use the privileged service, the session token enabling the custom class loader to load one or more classes associated with the privileged service.

7. The method of claim 6, wherein the session token received by the client is stored at the client for subsequent use.

8. The method of claim 1, further comprising:
upon determining that the client provides a valid session token with the request, the client may be granted access to the requested service.

9. The method of claim 1, further comprising:
adding a new privileged service in addition to the one or more privileged services offered by the service provider; and
serving the new privileged service to the client without modifying any file in the software package.

10. The method of claim 2, further comprising:
upon determining the client is invalid, terminating the validation process and sending an error code to the custom class loader, the error code indicating the client is invalid.

11. The method of claim 2, further comprising:
upon determining the client is invalid, creating a dummy object in which all calls made in relation to the dummy object comprise a no operation (no-op).

12. A computing device configured to authenticate an application, comprising:
a processor;
memory in electronic communication with the processor;
instructions stored in the memory, the instructions being executable by the processor to:
receive a software package;
authorize the software package based at least in part on an evaluation of the software package;
upon authorizing the software package, embed a signature file in a directory of the software package; and
receive, from a client, a request to use a privileged service provided by a service provider.

13. The computing device of claim 12, wherein the request comprises a custom class loader constructing a proxy object as an interface to the privileged service, the custom class loader utilizing a call to the privileged service to initiate validation of the client via the proxy object.

14. The computing device of claim 13, wherein the instructions are executable by the processor to:
query the client for information associated with the software package, wherein the information associated with the software package includes at least one of a process ID, a user ID, a path to the software package, a path to an element of the software package, and one or more permissions associated with the software package.

15. The computing device of claim 13, wherein the instructions are executable by the processor to:
evaluate the signature file of the client to determine whether the signature file is valid, wherein a valid signature file is signed by the service provider.

16. The computing device of claim 15, wherein the instructions are executable by the processor to:
upon determining the signature file is valid, evaluate a license of the client to determine whether the license is valid.

17. The computing device of claim 13, wherein the instructions are executable by the processor to:
upon determining that the client is valid, sending a session token to the client and notifying the client that the custom class loader is allowed to use the privileged service, the session token enabling the custom class loader to load one or more classes associated with the privileged service, wherein the session token received by the client is stored at the client for subsequent use.

18. The computing device of claim 13, wherein the instructions, upon determining the client is invalid, are executable by the processor to:
send an error code to the custom class loader, the error code indicating the client is invalid; and
create a dummy object in which all calls made in relation to the dummy object comprise a no operation (no-op)

19. A computer-program product for authenticating, by a processor, an application, the computer-program product comprising a non-transitory computer-readable medium storing instructions thereon, the instructions being executable by the processor to:
receive a software package;
authorize the software package based at least in part on an evaluation of the software package;
upon authorizing the software package, embed a signature file in a directory of the software package; and
receive, from a client, a request to use a privileged service provided by a service provider.

20. The computer-program product of claim 19, wherein the request comprises a custom class loader constructing a proxy object as an interface to the privileged service, the custom class loader utilizing a call to the privileged service to initiate validation of the client via the proxy object.
